(19) United States
(12) Patent Application Publication
(10) Pub. No.: US 2023/0000197 A1
(43) Pub. Date: Jan. 5, 2023

(54) Motorcycle Helmet Device

(71) Applicant: John Snowton, Addison, TX (US)

(72) Inventor: John Snowton, Addison, TX (US)

(21) Appl. No.: 17/853,496

(22) Filed: Jun. 29, 2022

Related U.S. Application Data
(60) Provisional application No. 63/217,886, filed on Jul. 2, 2021.

(51) Int. Cl. A42B 3/30; G06F 3/147; G01C 21/36

(52) U.S. Cl. CPC A42B 3/30; G06F 3/147; G01C 21/365

(57) ABSTRACT

The present invention relates to a motorcycle helmet device. The device is comprised of a body that has at least one LED and/or LED panel, a visor, a projector, a battery and a mobile application. The at least one LED and/or LED panel can further be customized using the mobile application to allow a user to change the appearance of the body depending upon their preferences. The projector further allows a GPS navigation software to be projected onto the visor such that a user can view the software while driving a motorcycle without having to take his or her eyes off of the road. In addition, the projector can allow a user to customize the appearance of the visor.

### CROSS-REFERENCE TO RELATED APPLICATION

The present application claims priority to, and the benefit of, U.S. Provisional Application No. 63/217,886, which was filed on Jul. 2, 2021 and is incorporated herein by reference in its entirety.

### FIELD OF THE INVENTION

The present invention relates generally to the field of motorcycle helmets. More specifically, the present invention relates to a motorcycle helmet device. The device is comprised of a body that has at least one LED and/or LED panel, a visor, a projector, a battery and a mobile application. The at least one LED and/or LED panel can further be customized using the mobile application to allow a user to change the appearance of the body depending upon their preferences. Accordingly, the present disclosure makes specific reference thereto. Nonetheless, it is to be appreciated that aspects of the present invention are also equally applicable to other like applications, devices and methods of manufacture.

### BACKGROUND

The National Highway Traffic Safety Administration estimates that since 2002 more than 25,000 lives have been saved by wearing motorcycle helmets. Motorcycle helmets are estimated to be 37% effective in preventing fatal injuries to motorcycle operators, and 41% effective for motorcycle passengers. However, many motorcycle riders may choose not to wear a motorcycle helmet due to their distaste regarding the look or appearance of motorcycle helmets available on the market today. This is obviously undesirable, as a motorcycle rider's safety greatly increases when wearing a motorcycle helmet. In addition, motorcycle riders often use a GPS or the GPS on their mobile phone to navigate on long motorcycle rides. When doing so, the GPS or mobile phone is typically mounted near the handlebars of the motorcycle. However, this can be dangerous because to view the GPS while riding a motorcycle, a rider must avert their eyes from the road and towards the position of the GPS/mobile phone. This is undesirable as it could lead to motorcycle accidents or crashes, which are often fatal. Finally, motorcycle riders are often involved in accidents at night, due to the fact that other drivers on the roadway cannot easily see the motorcycle or rider.

Therefore, there exists a long-felt need in the art for an improved motorcycle helmet. There also exists in the art a long-felt need for a motorcycle helmet device that presents a more visually appealing helmet option for motorcycle riders. Further, there exists a long-felt need in the art for a motorcycle helmet device that allows a user to view a GPS without averting his or her eyes from a roadway while driving a motorcycle. Finally, there exist a long-felt need in the art for a motorcycle helmet device that ensures a wearer can be adequately seen at night.

The subject matter disclosed and claimed herein, in one embodiment thereof, comprises a motorcycle helmet device. The device is comprised of a body that has at least one LED and/or LED panel, a visor, a projector, a battery and a mobile application. The at least one LED and/or LED panel can further be customized using the mobile application to allow a user to change the appearance of the body depending upon his or her preferences. The projector further allows GPS navigation software to be projected onto the visor such that a user can view the software while driving a motorcycle without having to take his or her eyes off of the road. In addition, the projector can allow a user to customize the appearance of the visor.

In this manner, the motorcycle helmet device of the present invention accomplishes all of the forgoing objectives and provides a motorcycle helmet that allows a user to customize the outer appearance of the device, therefore providing a more visually appealing helmet option. The device further allows a user to view GPS navigation software without having to avert his or her eyes from a roadway while driving a motorcycle. Finally, the device ensures a wearer can be adequately seen at night due to the illumination of the device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorcycle helmet device. The device is primarily comprised of a body that has at least one LED and/or LED panel, a visor, a projector, a battery and a mobile application. The device can be worn while driving or riding on a motorcycle or other vehicle, and has all the common features of motorcycle helmets known in the art, in addition to the novel improvements and features disclosed in this application. The body further has a hard outer shell and a soft inner liner. Any surface of the outer shell may further be comprised of at least one LED that may illuminate in any color known in the art, and can be configured and customized using a mobile application. The at least one LED may be further be present on an at least one LED panel that houses a group of LEDs. The outer shell may further have a plurality of fixedly-attached LEDs and/or a plurality of fixedly or removably-attached LED panels that cover the entire surface or only a portion of the surface of the outer shell. Further, one embodiment of the LED panel may additionally or alternatively contain an LCD display screen that can display color videos, photographs and images.

The body is also comprised of a transparent visor with at least one hinge that allows the visor to articulate up and down over the eyes of the user. The inner liner or the visor itself may further contain a small projector that can be controlled by the mobile application to allow a user to project a plurality of indicia onto the visor. The indicia can be viewed by a user while riding a motorcycle with the device on, and may be functional and in the form of but not limited to: weather conditions/weather updates, GPS navigation routes, estimated arrival times, mobile phone notifications (i.e., texts, phone calls, emails, etc.), speed limits, traffic alerts, fuel status, mileage, current speed, emergency alerts, etc. In addition, the indicia may be purely aesthetic and may be comprised of patterns, logos, emblems, images, symbols, designs, letters, words, characters, animals, advertisements, brands, etc. The projector and at least one LED and LED panel are further in electrical communication with and receive power from at least one battery housed within the inner liner, or from at least one solar panel that may be located on the outer shell.

The mobile application can be used on any smart device and is in Bluetooth communication with the device via a transmitter that is housed within the inner liner. The mobile application is further comprised of a configuration software and a GPS navigation software. The configuration software allows a user to customize the color and brightness of the at least one LED and the at least one LED panel, and may also allow a user to create a custom arrangement with the at least one LED and/or the at least one LED panel to create any number of patterns, logos, emblems, images, symbols, designs, letters, words, characters, animals, advertisements, etc. The software may also allow a user to upload a custom image and automatically configures the LEDs and/or LED panels to create the desired patterns, logos, emblems, images, symbols, designs, letters, words, characters, animals, advertisements, etc.

The GPS navigation software allows a user to select a destination and develop and display a route to said destination from a starting point chosen by the user or automatically detected by the software. The software preferably has features including but not limited to: estimated time of arrival, a visual display of the GPS route, weather conditions/weather updates, speed limits, traffic alerts, fuel status, mileage, current speed, emergency alerts, etc., wherein the features can then be displayed on the visor for the user to view while driving a motorcycle, and while wearing the device with the visor down.

Accordingly, the motorcycle helmet device of the present invention is particularly advantageous as it allows a user to customize the outer appearance of the device to provide a more visually appealing helmet option. The device further allows a user to view a GPS navigation software without having to avert his or her eyes from a roadway while driving a motorcycle, which increases the safety of the user. Finally, the device ensures a user can be adequately seen at night via the illumination of the device to further increase the safety of the user while riding a motorcycle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the motorcycle helmet device of the present invention in accordance with the disclosed architecture;

FIG. 2 illustrates a side perspective view of one potential embodiment of the motorcycle helmet device of the present invention in accordance with the disclosed architecture; and

FIG. 3 illustrates a graphical view of the primary components of the mobile application used with one potential embodiment of the motorcycle helmet device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a motorcycle helmet that allows a user to customize the outer appearance of the device to provide a more visually appealing helmet option. There also exists a long-felt need in the art for a motorcycle helmet device that allows a user to view a GPS without averting his or her eyes from a roadway while driving a motorcycle. Finally, there exist a long-felt need in the art for a motorcycle helmet device that ensures a user can be adequately seen at night.

The present invention, in one exemplary embodiment, is comprised of a motorcycle helmet device primarily comprised of a body that has at least one LED and/or LED panel, a visor, a projector, a battery and a mobile application. The device can be worn while driving or riding on a motorcycle or other vehicle, and has all the common features of motorcycle helmets known in the art, in addition to the novel improvements and features disclosed in this application. The body further has a hard outer shell and a soft inner liner, wherein any surface of the outer shell may further be comprised of at least one LED that may illuminate in any color known in the art, and can be configured and customized using a mobile application. The at least one LED may further be present on at least one LED panel that houses a group of LEDs. The outer shell may further have a plurality of fixedly-attached LEDs and/or a plurality of fixedly or removably-attached LED panels that cover the entire surface or only a portion of the surface of the outer shell. In addition, one embodiment of the LED panel may additionally or alternatively contain an LCD display screen that can display color videos, photographs and images.

The body also comprises a transparent visor with at least one hinge that allows the visor to articulate up/down over the eyes of the user. The inner liner or the visor itself may further contain a small projector that can be controlled by a mobile application, to allow a user to project a plurality of indicia onto the visor, wherein the indicia can be viewed by a user while riding a motorcycle with the device on and may be functional and in the form of but not limited to: weather conditions/weather updates, GPS navigation routes, estimated arrival times, mobile phone notifications (i.e., texts, phone calls, emails, etc.), speed limits, traffic alerts, fuel status, mileage, current speed, emergency alerts, etc. In addition, the indicia may be purely aesthetic and may be comprised of patterns, logos, emblems, images, symbols, designs, letters, words, characters, animals, advertisements, brands, etc. The projector and at least one LED and LED panel are further in electrical communication with, and receive power from, at least one battery housed within the inner liner, or from an at least one solar panel that may be located on the outer shell.

The mobile application can be used with any smart device and is in Bluetooth communication with the device via a transmitter that is housed within the inner liner. The mobile application is further comprised of a configuration software and a GPS navigation software, wherein the configuration software allows a user to customize the color and brightness of the at least one LED and the at least one LED panel. The software also allows a user to create a custom arrangement with the at least one LED and/or the at least one LED panel to create any number of patterns, logos, emblems, images, symbols, designs, letters, words, characters, animals, advertisements, etc. The software may also allow a user to upload a custom image and automatically configures the LEDs and/or LED panels to create the desired patterns, logos, emblems, images, symbols, designs, letters, words, characters, animals, advertisements, etc.

In addition, the GPS navigation software allows a user to select a destination and develop and display a route to said destination from a starting point chosen by the user or automatically detected by the software. The software preferably has features including but not limited to: estimated time of arrival, a visual display of the GPS route, weather conditions/weather updates, speed limits, traffic alerts, fuel status, mileage, current speed, emergency alerts, etc., wherein the features can then be displayed on the visor for the user to view while driving a motorcycle and wearing the device with the visor down.

Therefore, the motorcycle helmet device of the present invention is particularly advantageous as it allows a user to customize the outer appearance of the device to provide a more visually appealing, custom helmet option. The device further allows a user to view a GPS navigation software without having to avert his or her eyes from a roadway while driving a motorcycle, which increases the safety of the user. Finally, the device ensures a user can be adequately seen at night via the illumination of the device to further increase the safety of the user while riding a motorcycle.

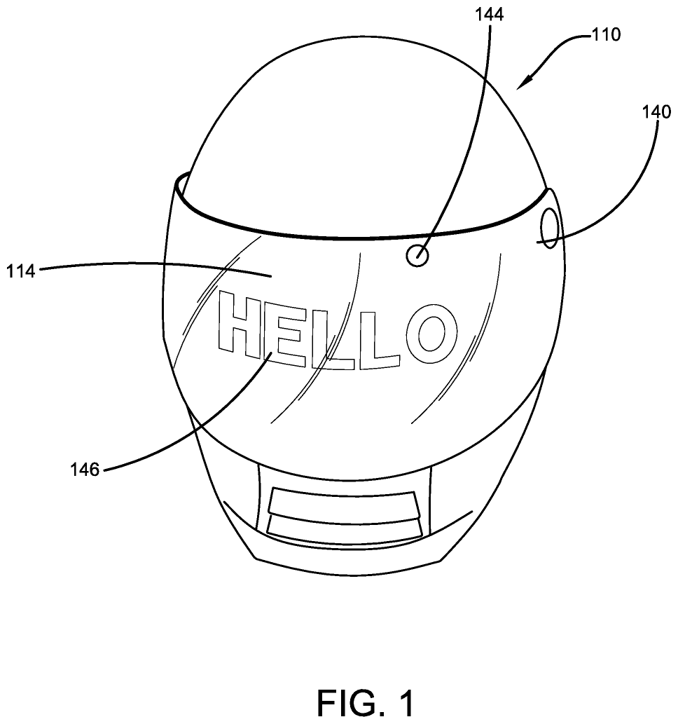

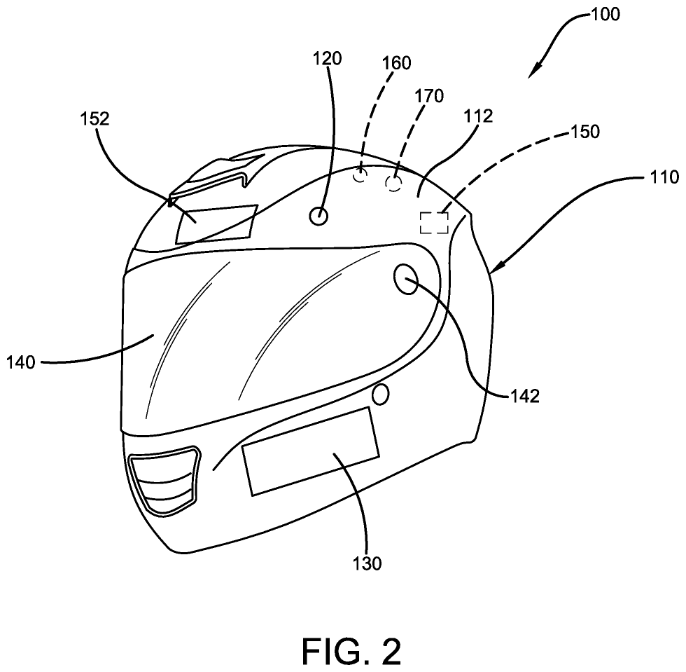

Referring initially to the drawings, FIGS. 1-2 illustrate a perspective view of one embodiment of the motorcycle helmet device 100 of the present invention. The device 100 is primarily comprised of a body 110 that has at least one LED 120 and/or at least one LED panel 130, a visor 140, a projector 144, a battery 150 and a mobile application 200. The device 100 can be worn while driving or riding on a motorcycle or other suitable vehicle as is known in the art. It should be appreciated that the device 100 has all the common features of motorcycle helmets known in the art, in addition to the novel improvements and features disclosed in this application.

The body 110 of the device 100 preferably has a hard outer shell 112 that may be manufactured of polycarbonate plastic, fiberglass, Kevlar, etc., or any other suitable material as is known in the art. The body 110 also has a soft inner liner 114 manufactured of expanded polystyrene foam, polypropylene foam, etc., or any other suitable material as is known in the art. Further, any surface of the outer shell 112 may be comprised of at least one LED 120. The at least one LED 120 may illuminate in any color known in the art, and can be configured and customized using a mobile application 200, as will be explained more fully below. In one embodiment, the at least one LED 120 may be present on an LED panel 130 that houses a group of LEDs 120. In this embodiment, the outer shell 112 may have a plurality of fixedly-attached LEDs 120 and/or a plurality of fixedly or removably-attached LED panels 130 that cover the entire surface, or only a portion of the surface, of the outer shell 112. It is also contemplated that in one embodiment, the LED panel 130 may additionally or alternatively contain an LCD display screen that can display color videos, photographs, images and other indicia.

Additionally, as shown in FIGS. 1-2, the body 110 of the motorcycle helmet device 100 is also comprised of a transparent visor 140 with at least one hinge 142 that allows the visor 140 to articulate up/down over the eyes of the user. In differing embodiments, the visor 140 may be tinted in any known color and/or tint percentage known in the art, depending on the needs and/or wants of a user. The inner liner 114 or the visor 140 itself may further contain a small projector 144. The projector 144 can be controlled by the mobile application 200 to allow a user to project/display a plurality of indicia 146 onto the visor 140, such that the indicia 146 can be viewed by a user while riding a motorcycle with the device 100 on. In differing embodiments, the indicia 146 may be functional and in the form of, but not limited to: weather conditions/weather updates, GPS navigation routes, estimated arrival times, mobile phone notifications (i.e., texts, phone calls, emails, etc.), speed limits, traffic alerts, fuel status, mileage, current speed, emergency alerts, etc. In addition, the indicia 146 may be purely aesthetic, and may be comprised of patterns, logos, emblems, images, symbols, designs, letters, words, characters, animals, advertisements, brands, etc.

The projector 144 and at least one LED 120/LED panel 130 is further in electrical communication with and receives power from at least one battery 150 housed within the inner liner 114. The battery 150 may be a disposable battery or a rechargeable battery in the form of an alkaline, nickel-cadmium, nickel-metal hydride battery, etc., such as any 3V-12 volt DC battery or other conventional battery such as A, AA, AAA, etc., that supplies power to the device 100. Throughout this specification the term “battery” may be used interchangeably to refer to one or more wet or dry cells or batteries of cells, in which chemical energy is converted into electricity and used as a source of DC power. References to recharging or replacing the battery 150 may refer to recharging or replacing individual cells, individual batteries of cells or a package of multiple battery cells as is appropriate for any given battery technology that may be used.

In addition or alternatively, the projector 144 and at least one LED 120/LED panel 130 may be in electrical communication with and receive power from at least one solar panel 152 that may be located on the outer shell 112. In differing embodiments of the device 100, the solar panel 152 may be comprised of but not limited to: monocrystalline silicon, polycrystalline silicon or a thin film that has at least one photovoltaic cell.

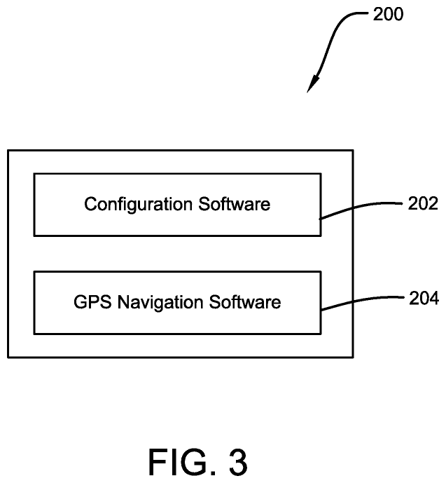

FIG. 3 illustrates a graphical view of the primary components of a mobile application 200 for the motorcycle helmet device 100 of the present invention. The mobile application 200 can be used with any smart device, and is in Bluetooth communication with the device 100 via a transmitter 160 that is housed within the inner liner 114. However, in differing embodiments the mobile application 200 and transmitter 160 may communicate via Wi-Fi, RFID, Cellular, etc., or any other suitable communication method known in the art. The mobile application 200 is further comprised of a configuration software 202 and a GPS navigation software 204. The configuration software 202 allows a user to customize the color and brightness of the at least one LED 120 and the at least one LED panel 130, wherein the customization is relayed to the transmitter 160 and then to a processor 170 which controls the LEDs 120 and LED panel 130. The configuration software 202 may also allow a user to create a custom arrangement with the at least one LED 120 and/or the at least one LED panel 130, to create any number of patterns, logos, emblems, images, symbols, designs, letters, words, characters, animals, advertisements, etc.

To accomplish this, the software 202 allows a user to individually select which LEDs 120 or LED panels 130 to illuminate, and in which color or brightness to create a desired arrangement. The software 202 may also allow a user to upload any number of his or her own custom patterns, logos, emblems, images, symbols, designs, letters, words, characters, animals, advertisements, etc., to display via the LEDs 120 and/or LED panels 130. To accomplish this, the software 202 automatically configures the LEDs 120 and/or LED panels 130 to create the desired patterns, logos, emblems, images, symbols, designs, letters, words, characters, animals, advertisements, etc. In this manner, the appearance of the outer shell 112 can be customized by the user to his or her individual liking, preference and style. Due to the illumination of the LEDs 120 and/or LED panels 130, the device 100 and user can therefore be better seen by other motorists while the user is driving a motorcycle at night.

The mobile application 200 is also comprised of a GPS navigation software 204 that allows a user to select a destination and develop and display a route to said destination, from a starting point chosen by the user or automatically detected by the software 204 (i.e., wherein the starting point is the current location of the device 100, the user or the smart device upon which the user is using the mobile application 200). The software 204 preferably has features including but not limited to: estimated time of arrival, a visual display of the GPS route, weather conditions/weather updates, speed limits, traffic alerts, fuel status, mileage, current speed, emergency alerts, etc., wherein the features can then be displayed on the visor 140 for the user to view while driving a motorcycle and wearing the device 100 with the visor 140 down. In this manner, the user has full access to all information that would otherwise be found in a GPS without having to dangerously take his or her eyes off the road surface while riding a motorcycle to look at a GPS.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorcycle helmet device” and “device” are interchangeable and refer to the motorcycle helmet device 100 of the present invention.

Notwithstanding the forgoing, the motorcycle helmet device 100 of the present invention and its various components can be of any suitable size and configuration as is known in the art without affecting the overall concept of the invention, provided that they accomplish the above-stated objectives. One of ordinary skill in the art will appreciate that the size, configuration and material of the motorcycle helmet device 100 as shown in FIGS. 1-3 is for illustrative purposes only, and that many other sizes and shapes of the motorcycle helmet device 100 are well within the scope of the present disclosure. Although the dimensions of the motorcycle helmet device 100 are important design parameters for user convenience, the motorcycle helmet device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorcycle helmet device comprising:
a body comprised of an outer shell and an inner liner;
at least one LED;
at least one LED panel;
a visor;
a projector;
a battery for powering the at least one LED and the at least one LED panel; and
a mobile application, wherein the at least one LED and the at least one LED panel are fixedly secured to the outer shell.

2. The motorcycle helmet device of claim 1, wherein the mobile application allows a user to change appearance and color of the at least one LED and/or the at least one LED panel.

3. The motorcycle helmet device of claim 1, wherein the projector projects a plurality of indicia onto the visor.

4. A motorcycle helmet device comprising:
a body comprised of an outer shell and an inner liner;
at least one LED located on the outer shell;
at least one LED panel located on the outer shell;
a visor;
a projector that projects on to the visor;
a battery;
a solar panel; and
a mobile application further comprised of a GPS navigation software and a configuration software, wherein the battery and the solar panel power the at least one LED and the at least one LED panel.

5. The motorcycle helmet device of claim 4, wherein the GPS navigation software allows a user to select a destination and develop and display a route to the destination from a starting point chosen by the user or automatically detected by the GPS navigation software.

6. The motorcycle helmet device of claim 5, wherein the projector displays the route onto the visor.

7. A motorcycle helmet device comprising:
a body comprised of an outer shell and an inner liner;
at least one LED located on the outer shell;
at least one LED panel located on the outer shell;
a visor that can articulate up and down over a pair of eyes of a user via a hinge;
a projector located within the inner liner that projects on to the visor;
at least one battery that powers the at least one LED and the at least one LED panel;
at least one solar panel that powers the at least one LED and the at least one LED panel;
and
a mobile application comprised of a GPS navigation software and a configuration software.

8. The motorcycle helmet device of claim 7, wherein the configuration software allows a user to change appearance and color of the at least one LED and/or the at least one LED panel.

9. The motorcycle helmet device of claim 8, wherein the at least one LED and the at least one LED panel cover an entire surface of the outer shell.

10. The motorcycle helmet device of claim 8, wherein the at least one LED and/or the at least one LED panel cover only a portion of a surface of the outer shell.

11. The motorcycle helmet device of claim 7, wherein the at least one LED panel is further comprised of an LCD display screen that can display a color video, a photograph, or an image.

12. The motorcycle helmet device of claim 7, wherein the projector is housed within the visor.

13. The motorcycle helmet device of claim 12, wherein the projector can be controlled by the mobile application to allow a user to display a plurality of indicia onto the visor, such that the plurality of indicia can be viewed by a user while riding a motorcycle.

14. The motorcycle helmet device of claim 13, wherein the plurality of indicia comprises at least one of a weather condition, a GPS navigation route, an estimated arrival time, a mobile phone notification, a speed limit, a traffic alert, a fuel status, a mileage, a current speed, an emergency alert, a pattern, a logo, an emblem, an image, a symbol, a design, a letter, a word, a character, an animal, an advertisement, or a brand.

15. The motorcycle helmet device of claim 7, wherein the configuration software allows a user to create a custom arrangement with the at least one LED and the at least one LED panel to create a plurality of indicia.

16. The motorcycle helmet device of claim 15, wherein the configuration software allows a user to upload a custom indicia comprising at least one of a pattern, a logo, an emblem, an image, a symbol, a design, a letter, a word, a character, an animal, an advertisement, or a brand, which is displayed via the at least one LED and the at least one LED panel.

17. The motorcycle helmet device of claim 7, wherein appearance of the outer shell can be customized by a user via illumination of the at least one LED and the at least one LED panel.

18. The motorcycle helmet device of claim 7, wherein the GPS navigation software allows a user to select a destination and develop and display a route to the destination from a starting point chosen by the user or automatically detected by the GPS navigation software.

19. The motorcycle helmet device of claim 18, wherein the projector displays the route onto the visor.

20. The motorcycle helmet device of claim 7, wherein the projector is powered by the at least one battery or the at least one solar panel.
